(19) United States
(12) Patent Application Publication
(10) Pub. No.: US 2025/0032908 A1
(43) Pub. Date: Jan. 30, 2025

(54) SURROUND HAPTIC EXPERIENCE FOR A GAMING CONTROLLER

(71) Applicant: Dell Products L.P., Round Rock, TX (US)

(72) Inventors: Wei-Hsiang Chi, Taipei (TW); Hsu-Feng Lee, Taipei City (TW)

(73) Assignee: Dell Products L.P., Round Rock, TX (US)

(21) Appl. No.: 18/361,803

(22) Filed: Jul. 28, 2023

(51) Int. Cl. A63F 13/285; A63F 13/42

(52) U.S. Cl. CPC A63F 13/285; A63F 13/42

(57) ABSTRACT

Systems and methods described herein may provide a system that enables game play or other application sessions from a set of candidate game hosts and environments to consumption devices of a user's choice while the user moves about their home between the different environments. The system may employ methods to determine where a user is located within the home, availability and selection of candidate game hosting and target environments, homing and direction of related I/O and audio-visual (AV) content for consumption. The solution accommodates multiple users simultaneously within the home, whether in single player, multiplayer using the same screen, or multiplayer using separate screen games. The solution may configure AV and input/output (I/O) such that multiple users can consume one or multiple games in the home simultaneously, whether in separate locations or when seated together in front of the same consumption device.

### FIELD OF THE DISCLOSURE

The instant disclosure relates to information handling systems. More specifically, portions of this disclosure relate to execution of applications in a multi-room user environment.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY

User input devices for interacting with information handling systems and other devices may include haptic feedback components to provide tactile feedback to the user. For example, a gaming controller including input controls for gaming applications (e.g., an omnipad, a joystick, buttons, triggers, and/or paddles) may include multiple haptic feedback components. Aspects of this disclosure provide coordinated control of the haptic feedback components to provide a surround experience that improves the user immersion in virtual environments, gaming applications, or other applications. A vector, having a distance and a direction, may be used to coordinate activation of the haptic feedback components. For example, directions may be mapped to combinations of haptic feedback components and distances may be mapped to levels (e.g., a combination of intensity or amplitude, duration, and/or frequency) of activation of the haptic feedback components identified by the direction.

According to one embodiment, a gaming controller includes a plurality of input devices; a plurality of haptic feedback components, wherein one or more activated feedback components of the plurality of haptic feedback components are activated by mapping a direction and distance of a vector to the plurality of haptic feedback components. In certain embodiments, a level of vibration of the one or more activated feedback components is based on the distance corresponding to the vector; the level of vibration of the one or more activated feedback components is a first level when the distance exceeds a first threshold and is a second level when the distance exceeds a second threshold; and/or mapping the direction to the plurality of haptic feedback components comprises determining one of a plurality of predefined directions corresponds to the direction, and the one or more activated feedback components correspond to haptic feedback components associated with the one of the plurality of predefined directions. Example applications for the surround haptic experience may include using the vector to indicate a location of a user (e.g., an enemy) in a virtual environment and/or using the vector to indicate a location of a display device relative to the gaming controller.

The vector may be provided to the gaming controller, and the mapping performed by a microcontroller (or other processor or combination of processors) in the gaming controller to determine one or more haptic feedback components to activate and a corresponding level for each of the haptic feedback components based on the direction and the distance of the vector. In some embodiments, the vector may be received from an application (e.g., a gaming application) executing on an information handling system (e.g., a hub device) and transmitted through a wireless connection to the gaming controller for mapping. In some embodiments, the vector may be processed by the information handling system (e.g., hub device) and translated into a series of commands transmitted wirelessly to the gaming controller for activating mapped haptic feedback components, which may reduce computational requirements at the gaming controller. When the gaming controller includes a microcontroller for mapping the vector to haptic feedback components, the gaming controller may be configured similarly to an information handling system as described in embodiments herein with at least one processor and a memory with the at least one processor configured to perform the mapping of the vector to the haptic feedback components and control signaling on wires to control the haptic feedback components.

The method may be embedded in a computer-readable medium as computer program code comprising instructions that cause a processor to perform operations corresponding to the steps of the method. In some embodiments, the processor may be part of an information handling system including a first network adaptor configured to transmit data over a first network connection; and a processor coupled to the first network adaptor, and the memory.

As used herein, the term “coupled” means connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially parallel includes parallel), as understood by a person of ordinary skill in the art.

The phrase “and/or” means “and” or “or”. To illustrate, A, B, and/or C includes: A alone, B alone, C alone, a combination of A and B, a combination of A and C, a combination of B and C, or a combination of A, B, and C. In other words, “and/or” operates as an inclusive or.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus or system that “comprises,” “has,” or “includes” one or more elements possesses those one or more elements, but is not limited to possessing only those elements. Likewise, a method that “comprises,” “has,” or “includes,” one or more steps possesses those one or more steps, but is not limited to possessing only those one or more steps.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating aspects of a configurable system for providing services to users according to some embodiments of the disclosure.

FIG. 2 is a block diagram illustrating possible game environments according to some embodiments of the disclosure.

FIG. 3A is a block diagram illustrating application and services hosted in different gaming environments according to some embodiments of the disclosure.

FIG. 3B is a block diagram illustrating application and services hosted in different gaming environments according to some embodiments of the disclosure.

FIG. 3C is a block diagram illustrating application and service hosted in a common gaming environment according to some embodiments of the disclosure.

FIG. 3D is a block diagram illustrating a cloud-based service arrangement for a gaming environment according to some embodiments of the disclosure.

FIG. 4 is a top-down view of a gaming controller with a plurality of haptic feedback components for a surround experience according to some embodiments of the disclosure.

FIG. 5 is a top-down view of a gaming controller illustrating directions associated with groups of haptic feedback components according to some embodiments of the disclosure.

FIG. 6 is a flow chart illustrating a method of applying haptic feedback for a surround experience according to some embodiments of the disclosure.

FIG. 7 is an illustration of a mapping of distance of a vector to haptic feedback components according to some embodiments of the disclosure.

FIGS. 8A-8B are example mappings of distance and direction of a vector to haptic feedback components according to some embodiments of the disclosure.

FIGS. 9A-9B are example applications for surround haptic experiences according to some embodiments of the disclosure.

FIG. 10 is a perspective view of a gaming controller with different haptic feedback components according to some embodiments of the disclosure.

FIG. 11 is a schematic block diagram of an example information handling system according to some embodiments of the disclosure.

### DETAILED DESCRIPTION

These example embodiments describe and illustrate various aspects of a gaming controller with surround haptics that can improve the user's experience when interacting with devices and applications. The gaming controller may be used, in some embodiments, in a configurable and dynamic gaming environment that can be supported through the use of a hub device, which may be an information handling system.

In some embodiments, the aspects described herein may be used to support the execution of gaming applications in different environments. Gaming sessions may execute on a service, either locally on a device, on another system on the network, or in the cloud. A device may access the gaming session by executing an application that communicates with the service to receive and transmit user input to the service and provide feedback to the user from the service. The device may include its own audio/visual (AV) output for displaying a graphical user interface and/or a rendered display from the gaming session. Different environments at a location may include different AV systems, and the device may be automatically paired with an AV system and may be reconfigured to support interaction with an application session using the paired AV system.

A user's home is one example location that may have multiple environments, such as a living room, a dining room, a study, and/or a bedroom, each with different screen configurations, speaker configurations, and/or network availability. Aspects of embodiments disclosed herein may provide a system that enables game play from a set of candidate game hosts and environments to consumption devices of a user's choice while the user moves about their home between the different environments. The system may employ methods to determine where a user is located within the home, availability and selection of candidate game hosting and target environments, homing and direction of related I/O, and/or AV for consumption. The system then migrates the user and their information to the determined environment by coordinating gameplay by the user. The solution accommodates multiple users simultaneously within the home, whether in single player, multiplayer using the same screen, or multiplayer using separate screen games. The solution may configure AV and input/output (I/O) such that multiple users can consume one or multiple games in the home simultaneously, whether in separate locations or when seated together in front of the same consumption device, e.g., a large television, where multiple games might be hosted simultaneously.

The mobility of a user between services and applications for executing an application session may be supported by an information handling system that uses available telemetry from multiple sources to build a confidence-based knowledge graph of the user's gaming environments and determine a position of the user within that graph. A system with knowledge of devices in a user's gaming environment may build a knowledge graph by aggregating and comparing telemetry. For example, network telemetry may reveal that devices are positioned relatively near each other, a mobile device may reveal an absolute location based on GPS data, and/or an infrared presence sensor may reveal that the user is sitting in front a device. An intelligent system may assemble these individual pieces of telemetry into a broader knowledge graph based on the absolute and/or relative locations of the user's devices, the location of the user in relation, and or characteristics of the devices. This knowledge graph may be updated in real time and/or based on changes in device telemetry.

A hub device may be located in a user's home and used to arrange game play sessions (or more generically application sessions) between host devices and services. The host devices may execute an application for receiving an AV stream for displaying rendered content from a game play session (or other application session), and in some configurations also receive user input for interacting with the session from a peripheral device, such as a gaming controller. The AV stream presented by the host device may be generated by a service. The service may execute on the hub device or another information handling system, such as a cloud computing resource. A home may include one or several host devices (e.g., televisions, mobile computers, tablet computers, and personal computers) and may include one or several information handling systems executing the service (e.g., a hub devices and personal computers).

The user's home may be divided into different environments defined by a space around a host device. For example, a living room with a television may be one environment and a bedroom with a personal computer may be another environment. A user may use a peripheral device in one of the environments and the hub device may configure a host device, a service, and the peripheral device for operation in the environment by determining the corresponding environment using a knowledge graph. The knowledge graph provides a database of historical information about the environments from which the hub device may use current characteristics of the peripheral device to deduce the location, and thus current environment, of the peripheral device. For example, the knowledge graph may include information about location of rooms (e.g., environments) in the house based on wireless signatures of devices within the different rooms. This difference in signatures reflects that a device on a one side of the house may receive beacon signals from different neighboring access points than a device on an opposite side of the house. When a user carries the peripheral device around the house, the hub device may determine a location of the peripheral device based on visible access points to the peripheral device. Other example characteristics beyond wireless signature for determining location are described in further detail below, and the knowledge graph may be used to combine different characteristics to identify the location, and thus environment, of the peripheral device.

Based on the location of the peripheral device determined from the knowledge graph, the hub device may initialize an application session for the peripheral device by determining an appropriate host device and service for the application session. For example, if the peripheral device is in the living room and is requesting a game that is within the capabilities of the service on the hub device to execute, the hub device may initialize an application session for the peripheral device between the television as a consumption device and the hub device as a service. The service on the hub device executes the game and streams rendered content to an application executing on the television consumption device.

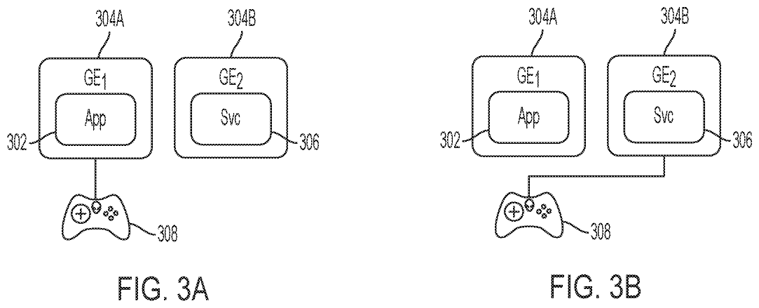

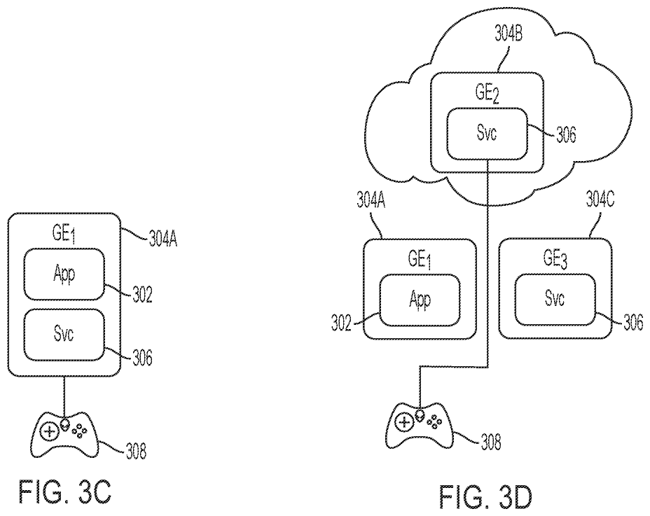

The hub device may be used to migrate the peripheral device to a different environment and/or migrate the application session between host devices and/or services. For example, initially the application session may use a communication link between the peripheral device and the television host device for receiving user input, in which the application executing on the television host device relays user input to the service through a backhaul communication link from the television host device to the hub device. During the application session, the hub device may monitor characteristics of the peripheral device, including signal strength of connection to other components, and determine that the communication link from the peripheral device to the hub device is stronger than the peripheral device to the television host device. The hub device may migrate the peripheral device to a communications link with the hub device such that the service executing on the hub device directly receives the user input but the streaming session continues from the service to the application executing on the television host device. Such a change is illustrated in the change in configuration from FIG. 3A to the configuration of FIG. 3B described in further detail below.

Other aspects of the application session may also be migrated. For example, if the peripheral device is determined to move to a different environment, then the hub device may migrate the application session to an application executing on a host device within the new environment. As another example, if a connection between the television host device and the service becomes unstable, the hub device may recommend and/or initiate a migration of the application session to a different host device. One scenario for such a migration may be where the television host device is connected through a wireless link to the service in which the wireless link quality is reducing quality of the streaming and a second host device with a wired connection is available in a nearby environment. Each of these example migrations may be determined based on information in the knowledge graph regarding locations of environments and capabilities within those environments. As yet another example, a user may request execution of an application, such as a particular game, during the application session for which a better configuration exists than the current host device and/or current service. The request for a different application, such as a game requiring a certain GPU capability, may cause the hub device to determine that a second device executing a second service is better for hosting the application and migrate the peripheral device to the second service by, for example, reconfiguring network connections.

The hub device may support connecting to multiple peripheral devices. In one example, the hub device may support two peripheral devices using a shared session on one host device to play the same or different games on the host device. In another example, the hub device may support two peripheral devices in different environments using different sessions with different host devices. The hub device may determine the environment of each of the peripheral devices based on characteristics of the device and the knowledge graph and configure application session for each of the peripheral devices accordingly. Different arrangements of peripherals and players may be supported. For example, one hub device executing a service and one host device executing an application can support a configuration with Game A and one player (P1) with peripheral (C1) and Game B and one player (P2) with peripheral (C2); or can support a configuration with Game A and one player (P1) with peripheral (C1) and Game A and one player (P2) with peripheral (C2); or can support a configuration with Game A and two players (P1, P2) with peripherals (C1, C2).

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

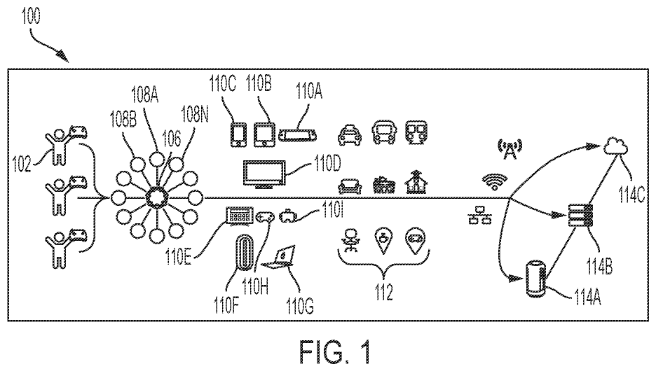

FIG. 1 is a block diagram illustrating aspects of a configurable system for providing services to users according some embodiments of the disclosure. A system 100 includes users 102 who may have access to a shared library of applications 106 including applications 108A-108N. The users 102 may have separate libraries, with some overlapping applications between the libraries. The users 102 may access the library 106 through devices 110A-I, such as mobile gaming device 110A, tablet computing device 110B, phone computing device 110C, television 110D, personal computing device 110E, desktop computing device 110F, laptop computing device 110G, game controller 110H, VR headset 110I. The devices 110 may access services at any of locations 112, including cars, busses, homes, hotels, offices, parks, etc. One or more of the devices 110 may communicate with an application session executing on a computing device 114, such as a home application hub 114A, a server 114B, or a cloud execution environment 114C. In some embodiments, environments may only exist for fixed devices, e.g., desktop computers, televisions, etc.

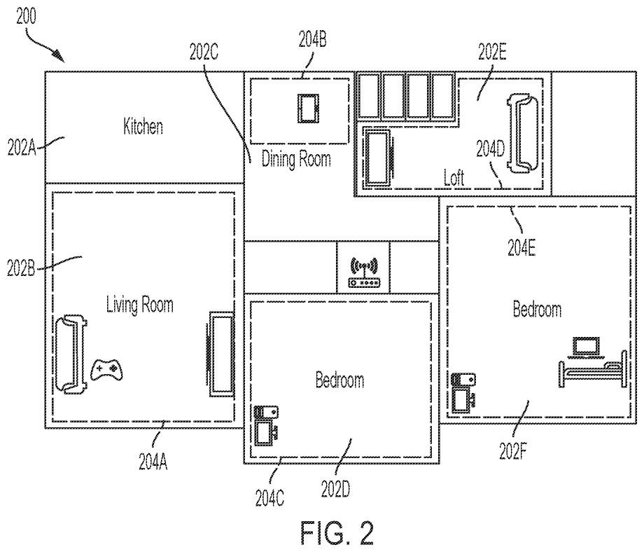

FIG. 2 is a block diagram illustrating possible game environments according to some embodiments of the disclosure. A user's home 200 may include rooms 202A-F, and each of the rooms may have different information handling systems present, different AV equipment present, and/or different characteristics. For example, a living room 202B may include a large-size television, a bedroom 202D may include a personal computer, and a dining room 202C may include a table computing device. Gaming environments 204A-E in the home 200 may be defined based on spaces where a user is likely to execute an application session. Each gaming environment 204A-E may include numerous devices and gaming environments, devices that may or may not be capable of hosting games, and/or devices that may or may not be capable of receiving game output. A system 100 may allow multiple users in the home 200 to simultaneously execute an application session. In some embodiments, multiple games may be hosted on a single device. In some embodiments, multiple games may target a single output device. In some embodiments, solution manages where games should be hosted, where game output should go, and how to best route peripheral I/O for users.

A user may move between gaming environments 204A-E within the home 200 and continue an application session. For example, a user may take a device, such as a gaming controller, from environment 204A to environment 204C. The gaming controller may migrate and reconfigure for operation in environment 204C from a configuration for environment 204A. For example, the controller may transition from an application hosted on a TV in living room 202B to an application hosted on TV in dining room 202C while remaining connected to a host service executing on a PC in bedroom 202D.

Example configurations for applications and services in gaming environments are shown in FIGS. 3A-3D. FIG. 3A is a block diagram illustrating application and services hosted in different gaming environments according to some embodiments of the disclosure. In FIG. 3A, a first gaming environment 304A may include a device, such as a TV or PC, hosting an application 302, which is an endpoint for an application session such as a gaming session. The application 302 communicates with a service 306, which may be hosted on a device in a different gaming environment 304B. A controller 308 may communicate with the application 302 to receive user input for the application session to control, for example, a character in a game. In some embodiments, the controller 308 is connected to the environment 304A hosting the application and the I/O is configured to be relayed to the environment 304B hosting the actual game.

Another arrangement for the application and service is shown in FIG. 3B. FIG. 3B is a block diagram illustrating application and services hosted in different gaming environments according to some embodiments of the disclosure. In FIG. 3B, the controller 308 communicates with the service 306 for providing user input to an application session, with the AV rendering target of the application session being application 302 in a different gaming environment.

Another arrangement for the application and service is shown in FIG. 3C. FIG. 3C is a block diagram illustrating application and service hosted in a common gaming environment according to some embodiments of the disclosure. In FIG. 3C, the application 302 and the service 306 are executed in the same gaming environment 304A, which may be a single device, two devices, or a combination of devices in the gaming environment 304A. The controller 308 may communicate with either the service 306 and/or the application 302.

A further arrangement for the application and service is shown in FIG. 3D. FIG. 3D is a block diagram illustrating a cloud-based service arrangement for a gaming environment according to some embodiments of the disclosure. In FIG. 3D, the controller 308 may communicate with a service 306 hosted in a gaming environment 304B that is remote from the gaming environment 304A in which the application 302 is executing. The service 306 may be executing, for example, on a remote device, such as when the user's home includes the gaming environment 304B but the user is engaging with application 302 at a location on a different network from their home (e.g., at a friend's house). The service 306 may also or alternatively be executed, for example, on a cloud computing device available as a subscription service to the user.

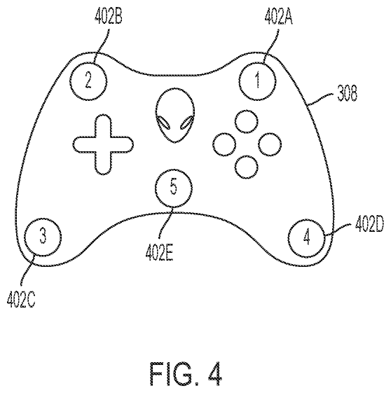

FIG. 4 is a top-down view of a gaming controller with a plurality of haptic feedback components for a surround experience according to some embodiments of the disclosure. One embodiment of a gaming controller 308 described with reference to FIG. 1, FIG. 2, and FIGS. 3A-3D above may include a plurality of haptic feedback components. For example, controller 308 may include haptic feedback components 402A-402E. Haptic feedback components may include, for example, rumble motors, coin vibration motor, cylindrical vibration motors, and/or linear resonant actuators (LRAs). The haptic feedback components 402A-402E may be arranged in different locations around the controller 308 such that difference haptic responses may be applied to different portions of the controller 308 while in the user's hand. The different haptic responses may be coordinated through appropriate control of the haptic components 402A-402E to provide a haptic feedback that approximates a direction and a distance corresponding to a vector.

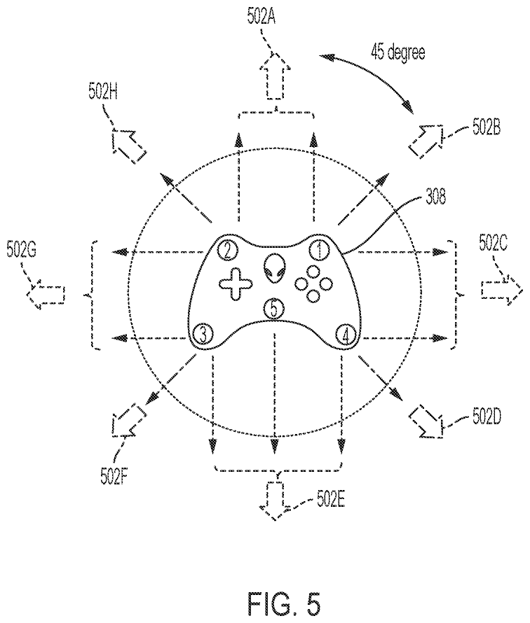

An example mapping of haptic feedback components 402A-402E to a plurality of directions is shown in FIG. 5. FIG. 5 is a top-down view of a gaming controller illustrating directions associated with groups of haptic feedback components according to some embodiments of the disclosure. Haptic feedback may be provided by components 402A-402E to simulate directions 502A-502H. For example, haptic feedback along a first direction 502A may be provided from components 402A and 402B. As another example, haptic feedback along a second direction 502B may be provided by component 402A. As more examples, haptic feedback along a third direction 502C may be provided by components 402A and 402D, haptic feedback along a fourth direction 502D may be provided by component 402D, haptic feedback along a fifth direction 502E may be provided by components 402C, 402D, and 402E, haptic feedback along a sixth direction 502F may be provided by component 402C, haptic feedback along a seventh direction 502G may be provided by components 402B and 402C, and haptic feedback along an eighth direction 502H may be provided by component 402B.

The directions 502A-502H may be predefined directions for haptic feedback that activate particular components. For example, mapping the direction of a feedback vector to the plurality of haptic feedback components may include determining one of a plurality of predefined directions (e.g., directions 502A-502H) corresponds to the direction (of the vector), and the one or more activated feedback components correspond to haptic feedback components associated with the one of the plurality of predefined directions. In some embodiments, a direction to an enemy user in a virtual environment may be approximated as one of the predefined directions 502A-502H. In the example of FIG. 5, the predefined directions 502A-502H are 45 degree increments around a 360 degree circle, but in other implementations the directions may be unequally spaced around the 360 degree circle and/or have more or fewer predefined directions.

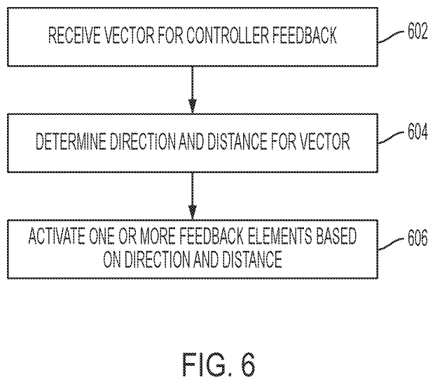

Haptic feedback components as described in embodiments herein may be activated based on a vector as shown in the method of FIG. 6. FIG. 6 is a flow chart illustrating a method of applying haptic feedback for a surround experience according to some embodiments of the disclosure. A method for providing surround haptic feedback may include, at block 602, receiving a vector for controller feedback. The vector may indicate, for example, a vector to another user in a virtual environment and/or a vector to a physical location of a device for operating from the controller. The vector may be determined by an information handling system, such as a gaming hub, and communicated to the controller as a vector through a wireless connection, such as Wifi or Bluetooth. For example, during an application session, such as described in the examples of FIGS. 3A-3D in which the gaming controller is communicating with the hub device, the hub device may provide instructions to activate haptic feedback using vectors to improve the user's immersion in the application session. The vector may alternatively be determined by the controller. For example, the controller may use local location information (e.g., signal strength and/or signal direction) to provide the user with haptic feedback to guide the user of the gaming controller between different gaming environments.

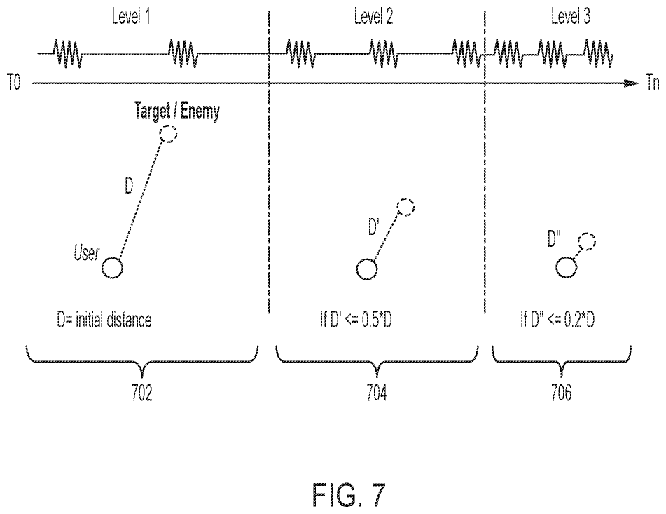

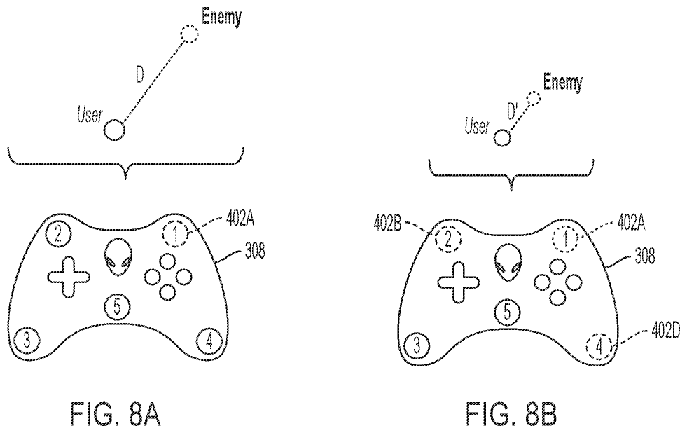

At block 604, a direction and distance corresponding to the vector may be determined. Block 604 may include, for example, adjusting the received vector to match one of a plurality of predefined directions specified in a mapping to the haptic feedback components. In some embodiments, the received vector may already be aligned with the available, predefined directions and the determination of block 604 is processing the received signal at block 602 to obtain one or more values (e.g., numerical values or indices) corresponding to the direction and/or distance. The direction and distance may be used to determine the activation of haptic feedback components in the gaming controller at block 606. Block 606 may include, for example, using the direction and distance of block 604 to determine a mapping to haptic feedback components. Block 606 may use a look-up table, formulas, or other functions to map the direction and/or distance to intensities for specific haptic feedback components, such as described with reference to FIG. 5, FIG. 7, and FIGS. 8A-8B.

The distances of the vector may change an intensity and/or frequency of haptic feedback provided by certain haptic feedback components. An example of the effect of distances is shown in FIG. 7. FIG. 7 is an illustration of a mapping of distance of a vector to haptic feedback components according to some embodiments of the disclosure. The distance value may be compared to one or more thresholds to determine how to activate certain haptic feedback components. A first level 702 may correspond to a first distance threshold, a second level 704 may correspond to a second distance threshold, and a third level 706 may correspond to a third distance threshold. At a distance in a first range, the first level 702 of haptic feedback may be bursts at a first frequency, at a distance in a second range, the second level 704 of haptic feedback may be bursts at a second frequency, and at a distance in a third range, the third level 706 of haptic feedback may be bursts at a third frequency. As such, the level of vibration of the one or more activated feedback components is a first when the distance exceeds a first threshold and is a second level when the distance exceeds a second threshold. Which haptic feedback components are activated at the first level 702, the second level 704, or the third level 706 may be determined by the direction corresponding to the vector.

In some embodiments, low levels may correspond to no activity for certain feedback components or different levels of activity for different feedback components. FIGS. 8A-8B are example mappings of distance and direction of a vector to haptic feedback components according to some embodiments of the disclosure. In FIG. 8A, the direction of the vector may map to haptic feedback components 402A, 402B, and 402D. The distance, however, is large enough such that the first level of intensity is applied only to haptic feedback component 402A. In FIG. 8B, the direction of the vector may again map to haptic feedback components 402A, 402B, and 402D. The distance is now small enough such that the second level of intensity is applied to haptic feedback component 402A and the first level of intensity is applied to haptic feedback components 402B and 402D.

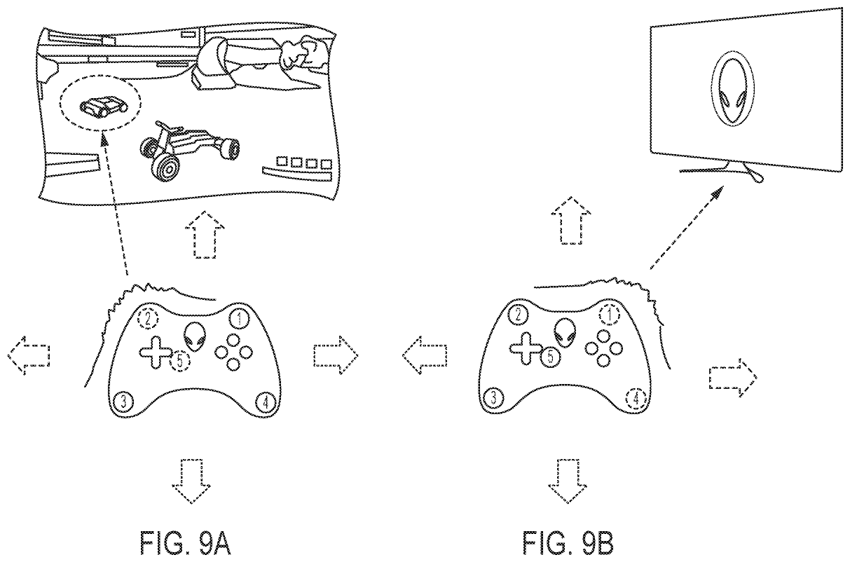

The haptic feedback provided according to examples above may be used to provide feedback to the user to improve their experience interacting with the gaming controller and other devices (e.g., the hub device or TVs and PCs in environments 204A-204E) and applications (e.g., applications executing on the hub device, on a cloud computing system, and/or on the TVs and PCs) through the gaming controller. FIGS. 9A-9B are example applications for surround haptic experiences according to some embodiments of the disclosure.

In FIG. 9A, the controller may provide haptic feedback indicating a location of another user in the virtual environment. For example, haptic feedback along the vector 902 may provide the user a non-visual indication of a direction to another user relative to the user's location in the virtual environment.

In FIG. 9B, the controller may provide haptic feedback guiding the user to a particular device in the gaming environment. For example, haptic feedback along vector 904 may provide the user a non-visual indication of a direction to a display device to interact with the hub device. As described above, the hub device is capable of executing an application and providing the corresponding AV stream to any device within the different environments. When a user is transitioning from one display device in a first environment to another display device in a second environment, the user may be provided haptic feedback through vector 904 to guide the user towards the display device in the second environment. The vector 904 may be received by the gaming controller from the hub device, with the hub device tracking the movement of the gaming controller and providing updated vectors as the controller moves. The vector 904 may be received by the gaming controller from a controller in the gaming controller that monitors the movement of the gaming controller and provides a new vector. The controller may be activated by the hub device sending a command to transition to a new environment along with an indication of the new environment from which the controller can determine direction.

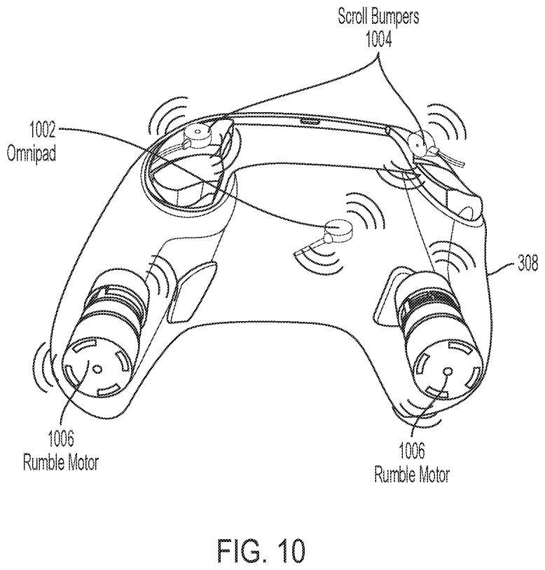

In some embodiments, the gaming controller 308 may implement different haptic feedback components in different locations as shown in FIG. 10. FIG. 10 is a perspective view of a gaming controller with different haptic feedback components according to some embodiments of the disclosure. The gaming controller 308 in the embodiment of FIG. 10 includes rumble motors 1006 in handles and coin vibration motors in scroll bumpers 1004 and omnipad 1002. As shown in FIG. 10, some of the plurality of haptic feedback components may be associated with one of a plurality of input devices of the gaming controller.

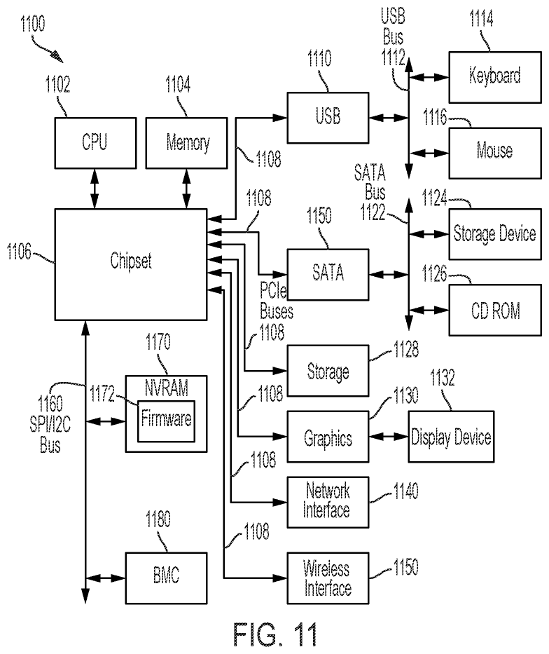

FIG. 11 illustrates an example information handling system 1100. Information handling system 1100 may include a processor 1102 (e.g., a central processing unit (CPU)), a memory (e.g., a dynamic random-access memory (DRAM)) 1104, and a chipset 1106. In some embodiments, one or more of the processor 1102, the memory 1104, and the chipset 1106 may be included on a motherboard (also referred to as a mainboard), which is a printed circuit board (PCB) with embedded conductors organized as transmission lines between the processor 1102, the memory 1104, the chipset 1106, and/or other components of the information handling system. The components may be coupled to the motherboard through packaging connections such as a pin grid array (PGA), ball grid array (BGA), land grid array (LGA), surface-mount technology, and/or through-hole technology. In some embodiments, one or more of the processor 1102, the memory 1104, the chipset 1106, and/or other components may be organized as a System on Chip (SoC).

The processor 1102 may execute program code by accessing instructions loaded into memory 1104 from a storage device, executing the instructions to operate on data also loaded into memory 1104 from a storage device, and generate output data that is stored back into memory 1104 or sent to another component. The processor 1102 may include processing cores capable of implementing any of a variety of instruction set architectures (ISAs), such as the x86, POWERPC®, ARM®, SPARC®, or MIPS® ISAs, or any other suitable ISA. In multi-processor systems, each of the processors 1102 may commonly, but not necessarily, implement the same ISA. In some embodiments, multiple processors may each have different configurations such as when multiple processors are present in a big-little hybrid configuration with some high-performance processing cores and some high-efficiency processing cores. The chipset 1106 may facilitate the transfer of data between the processor 1102, the memory 1104, and other components. In some embodiments, chipset 1106 may include two or more integrated circuits (ICs), such as a northbridge controller coupled to the processor 1102, the memory 1104, and a southbridge controller, with the southbridge controller coupled to the other components such as USB 1110, SATA 1120, and PCIe buses 1108. The chipset 1106 may couple to other components through one or more PCIe buses 1108.

Some components may be coupled to one bus line of the PCIe buses 1108, whereas some components may be coupled to more than one bus line of the PCIe buses 1108. One example component is a universal serial bus (USB) controller 1110, which interfaces the chipset 1106 to a USB bus 1112. A USB bus 1112 may couple input/output components such as a keyboard 1114 and a mouse 1116, but also other components such as USB flash drives, or another information handling system. Another example component is a SATA bus controller 1120, which couples the chipset 1106 to a SATA bus 1122. The SATA bus 1122 may facilitate efficient transfer of data between the chipset 1106 and components coupled to the chipset 1106 and a storage device 1124 (e.g., a hard disk drive (HDD) or solid-state disk drive (SDD)) and/or a compact disc read-only memory (CD-ROM) 1126. The PCIe bus 1108 may also couple the chipset 1106 directly to a storage device 1128 (e.g., a solid-state disk drive (SDD)). A further example of an example component is a graphics device 1130 (e.g., a graphics processing unit (GPU)) for generating output to a display device 1132, a network interface controller (NIC) 1140, and/or a wireless interface 1150 (e.g., a wireless local area network (WLAN) or wireless wide area network (WWAN) device) such as a Wi-Fi® network interface, a Bluetooth® network interface, a GSM® network interface, a 3G network interface, a 4G LTE® network interface, and/or a 5G NR network interface (including sub-6 GHz and/or mmWave interfaces).

The chipset 1106 may also be coupled to a serial peripheral interface (SPI) and/or Inter-Integrated Circuit (I2C) bus 1160, which couples the chipset 1106 to system management components. For example, a non-volatile random-access memory (NVRAM) 1170 for storing firmware 1172 may be coupled to the bus 1160. As another example, a controller, such as a baseboard management controller (BMC) 1180, may be coupled to the chipset 1106 through the bus 1160. BMC 1180 may be referred to as a service processor or embedded controller (EC). Capabilities and functions provided by BMC 1180 may vary considerably based on the type of information handling system. For example, the term baseboard management system may be used to describe an embedded processor included at a server, while an embedded controller may be found in a consumer-level device. As disclosed herein, BMC 1180 represents a processing device different from processor 1102, which provides various management functions for information handling system 1100. For example, an embedded controller may be responsible for power management, cooling management, and the like. An embedded controller included at a data storage system may be referred to as a storage enclosure processor or a chassis processor.

System 1100 may include additional processors that are configured to provide localized or specific control functions, such as a battery management controller. Bus 1160 can include one or more busses, including a Serial Peripheral Interface (SPI) bus, an Inter-Integrated Circuit (I2C) bus, a system management bus (SMBUS), a power management bus (PMBUS), or the like. BMC 1180 may be configured to provide out-of-band access to devices at information handling system 1100. Out-of-band access in the context of the bus 1160 may refer to operations performed prior to execution of firmware 1172 by processor 1102 to initialize operation of system 1100.

Firmware 1172 may include instructions executable by processor 102 to initialize and test the hardware components of system 1100. For example, the instructions may cause the processor 1102 to execute a power-on self-test (POST). The instructions may further cause the processor 1102 to load a boot loader or an operating system (OS) from a mass storage device. Firmware 1172 additionally may provide an abstraction layer for the hardware, such as a consistent way for application programs and operating systems to interact with the keyboard, display, and other input/output devices. When power is first applied to information handling system 1100, the system may begin a sequence of initialization procedures, such as a boot procedure or a secure boot procedure. During the initialization sequence, also referred to as a boot sequence, components of system 1100 may be configured and enabled for operation and device drivers may be installed. Device drivers may provide an interface through which other components of the system 1100 can communicate with a corresponding device. The firmware 1172 may include a basic input-output system (BIOS) and/or include a unified extensible firmware interface (UEFI). Firmware 1172 may also include one or more firmware modules of the information handling system. Additionally, configuration settings for the firmware 1172 and firmware of the information handling system 1100 may be stored in the NVRAM 1170. NVRAM 1170 may, for example, be a non-volatile firmware memory of the information handling system 1100.

Information handling system 1100 may include additional components and additional busses, not shown for clarity. For example, system 1100 may include multiple processor cores (either within processor 1102 or separately coupled to the chipset 1106 or through the PCIe buses 1108), audio devices (such as may be coupled to the chipset 1106 through one of the PCIe busses 1108), or the like. While a particular arrangement of bus technologies and interconnections is illustrated for the purpose of example, one of skill will appreciate that the techniques disclosed herein are applicable to other system architectures. System 1100 may include multiple processors and/or redundant bus controllers. In some embodiments, one or more components may be integrated together in an integrated circuit (IC), which is circuitry built on a common substrate. For example, portions of chipset 1106 can be integrated within processor 1102. Additional components of information handling system 1100 may include one or more storage devices that may store machine-executable code, one or more communications ports for communicating with external devices, and various input and output (I/O) devices, such as a keyboard, a mouse, and a video display.

In some embodiments, processor 1102 may include multiple processors, such as multiple processing cores for parallel processing by the information handling system 1100. For example, the information handling system 1100 may include a server comprising multiple processors for parallel processing. In some embodiments, the information handling system 1100 may support virtual machine (VM) operation, with multiple virtualized instances of one or more operating systems executed in parallel by the information handling system 1100. For example, resources, such as processors or processing cores of the information handling system may be assigned to multiple containerized instances of one or more operating systems of the information handling system 1100 executed in parallel. A container may, for example, be a virtual machine executed by the information handling system 1100 for execution of an instance of an operating system by the information handling system 1100. Thus, for example, multiple users may remotely connect to the information handling system 1100, such as in a cloud computing configuration, to utilize resources of the information handling system 1100, such as memory, processors, and other hardware, firmware, and software capabilities of the information handling system 1100. Parallel execution of multiple containers by the information handling system 1100 may allow the information handling system 1100 to execute tasks for multiple users in parallel secure virtual environments.

The schematic or flow chart diagrams of FIG. 6 is generally set forth as a logical flow chart diagram. As such, the depicted order and labeled steps are indicative of aspects of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

If implemented in firmware and/or software, functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise random access memory (RAM), read-only memory (ROM), electrically-erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain representative advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. For example, although processors are described throughout the detailed description, aspects of the invention may be applied to the design of or implemented on different kinds of processors, such as graphics processing units (GPUs), central processing units (CPUs), and digital signal processors (DSPs). As another example, although processing of certain kinds of data may be described in example embodiments, other kinds or types of data may be processed through the methods and devices described above. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A gaming controller, comprising:
a plurality of input devices; and
a plurality of haptic feedback components,
wherein one or more activated feedback components of the plurality of haptic feedback components are activated by mapping a direction and distance of a vector to the plurality of haptic feedback components.

2. The gaming controller of claim 1, wherein the plurality of haptic feedback components comprises at least one rumble motor and at least one coin vibration motor.

3. The gaming controller of claim 1, wherein a level of vibration of the one or more activated feedback components is based on the distance corresponding to the vector.

4. The gaming controller of claim 3, wherein the level of vibration of the one or more activated feedback components is a first level when the distance exceeds a first threshold and is a second level when the distance exceeds a second threshold.

5. The gaming controller of claim 1, wherein mapping the direction to the plurality of haptic feedback components comprises determining one of a plurality of predefined directions corresponds to the direction, and the one or more activated feedback components correspond to haptic feedback components associated with the one of the plurality of predefined directions.

6. The gaming controller of claim 1, wherein the vector corresponds to a location of a user in a virtual environment.

7. The gaming controller of claim 1, wherein the vector corresponds to a location of a display device relative to the gaming controller.

8. The gaming controller of claim 1, wherein at least one of the plurality of haptic feedback components is associated with one of the plurality of input devices.

9. A method, comprising:
determining a vector for haptic feedback on a gaming controller;
mapping a direction and a distance of the vector to a plurality of haptic feedback components of the gaming controller; and
activating one or more activated feedback components of the plurality of haptic feedback components based on mapping the direction and the distance of the vector to the plurality of haptic feedback components.

10. The method of claim 9, wherein a level of vibration of the one or more activated feedback components is based on the distance corresponding to the vector.

11. The method of claim 10, wherein the level of vibration of the one or more activated feedback components is a first level when the distance exceeds a first threshold and is a second level when the distance exceeds a second threshold.

12. The method of claim 9, wherein mapping the direction to the plurality of haptic feedback components comprises determining one of a plurality of predefined directions corresponds to the direction, and the one or more activated feedback components correspond to haptic feedback components associated with the one of the plurality of predefined directions.

13. The method of claim 9, wherein the vector corresponds to a location of a user in a virtual environment.

14. The method of claim 9, wherein the vector corresponds to a location of a display device relative to the gaming controller.

15. An information handling system, comprising:
a memory;
a processor coupled to the memory, wherein the processor is configured to perform steps comprising:
determining a vector for haptic feedback on a gaming controller;
mapping a direction and a distance of the vector to a plurality of haptic feedback components of the gaming controller;
activating one or more activated feedback components of the plurality of haptic feedback components based on mapping the direction and the distance of the vector to the plurality of haptic feedback components.

16. The information handling system of claim 15, wherein a level of vibration of the one or more activated feedback components is based on the distance corresponding to the vector.

17. The information handling system of claim 16, wherein the level of vibration of the one or more activated feedback components is a first level when the distance exceeds a first threshold and is a second level when the distance exceeds a second threshold.

18. The information handling system of claim 15, wherein mapping the direction to the plurality of haptic feedback components comprises determining one of a plurality of predefined directions corresponds to the direction, and the one or more activated feedback components correspond to haptic feedback components associated with the one of the plurality of predefined directions.

19. The information handling system of claim 15, wherein the vector corresponds to a location of a user in a virtual environment.

20. The information handling system of claim 15, wherein the vector corresponds to a location of a display device relative to the gaming controller.
